(19) United States
(12) Patent Application Publication
(10) Pub. No.: US 2012/0310678 A1
(43) Pub. Date: Dec. 6, 2012

(54) MANAGING AN INSURNACE PLAN

(76) Inventors: Adrian Gore, Sandton (ZA); Herschel Phillip Mayers, Johannesburg (ZA)

(21) Appl. No.: 13/486,002

(22) Filed: Jun. 1, 2012

(30) Foreign Application Priority Data
Jun. 1, 2011 (ZA) 2011/04063

(51) Int. Cl. G06Q 40/08

(52) U.S. Cl. 705/4

(57) ABSTRACT

Managing an insurance plan includes receiving data relating to a life insurance policy of an insured person, the life insurance policy relating to in the event of the insured person dying, paying a predetermined amount to beneficiaries nominated in terms of the life insurance policy. Data relating to the occurrence of an insured event to the insured person is received, the insured event being an event other than dying. On the occurrence of the insured event, data is transmitted, including an instruction to pay an amount of funds to the insured person and reducing the predetermined amount to be paid to the beneficiaries nominated in the terms of the life insurance policy upon the death of the insured person, by an amount related to the amount of funds paid to the insured person for the insured event.

### CROSS-REFERENCE TO RELATED APPLICATIONS

This application claims priority to South African Patent Application Number 2011/04063 filed Jun. 1, 2011, the contents of which are hereby incorporated by reference.

### FIELD OF THE INVENTION

The present invention relates to a managing an insurance plan, and more particularly to providing additional benefits during an insureds life when needed.

### BACKGROUND

Individuals are able to purchase fixed amounts of life, disability or severe illness insurance before an insured event, to be paid out on the occurrence of the event, for example a severe illness or disability.

After the event has happened, it is often the case that the event was not covered, not adequately covered, and/or the insurer is unable or unwilling to pay.

### SUMMARY OF THE INVENTION

According to one example embodiment there is provided a method of managing an insurance plan, the method including: receiving data relating to a life insurance policy of an insured person, the life insurance policy relating to in the event of the insured person dying, paying a predetermined amount to beneficiaries nominated in terms of the life insurance policy; receiving data relating to the occurrence of an insured event to the insured person, the insured event being an event other than dying; on the occurrence of the insured event transmitting data including an instruction to pay an amount of funds to the insured person; and reducing the predetermined amount to be paid to the beneficiaries nominated in terms of the life insurance policy upon the death of the insured person by an amount related to the amount of funds paid to the insured person for the insured event.

The amount of the reduction of the predetermined amount is calculated based on a set of conversion factors. The insured event may be a life changing adverse event. The life changing adverse event may be one of the group consisting of: severe illness, capital disability, very high health medical expenses, a motor vehicle accident, spouse or child sickness or disability, converting cover into cash to meet the funding needs associated with longevity, death of a person other than the insured life and adverse moments in investment values.

The predetermined amount to be paid to the beneficiaries nominated in terms of the life insurance policy upon the death of the insured person is reduced by a predetermined ratio to the amount of funds paid to the insured person for the insured event. Typically, the reduction is greater than the amount of funds paid to the insured person for the insured event. In one example embodiment the ratio is altered depending on the life changing adverse event.

According to another example embodiment there is provided a system for managing an insurance plan, the system including: a receiving module for receiving data relating to a life insurance policy of an insured person, the life insurance policy relating to in the event of the insured person dying, paying a predetermined amount to beneficiaries nominated in terms of the life insurance policy, the receiving module for receiving further data relating to the occurrence of an insured event to the insured person, the insured event being an event other than dying;

a calculation module to calculate a reduction in the predetermined amount to be paid to the beneficiaries nominated in terms of the life insurance policy upon the death of the insured person by an amount related to an amount of funds to be paid to the insured person for the insured event; and a transmitting module to, on the occurrence of the insured event, transmit data including an instruction to pay an amount of funds to the insured person.

### BRIEF DESCRIPTION OF THE DRAWINGS

A more complete understanding of the present invention, and the attendant advantages and features thereof, will be more readily understood by reference to the following detailed description when considered in conjunction with the accompanying drawings, in which:

FIG. 1 is a block diagram illustrating an example system to implement the methodologies described herein;

FIG. 2 is a block diagram illustrating an example embodiment method; and.

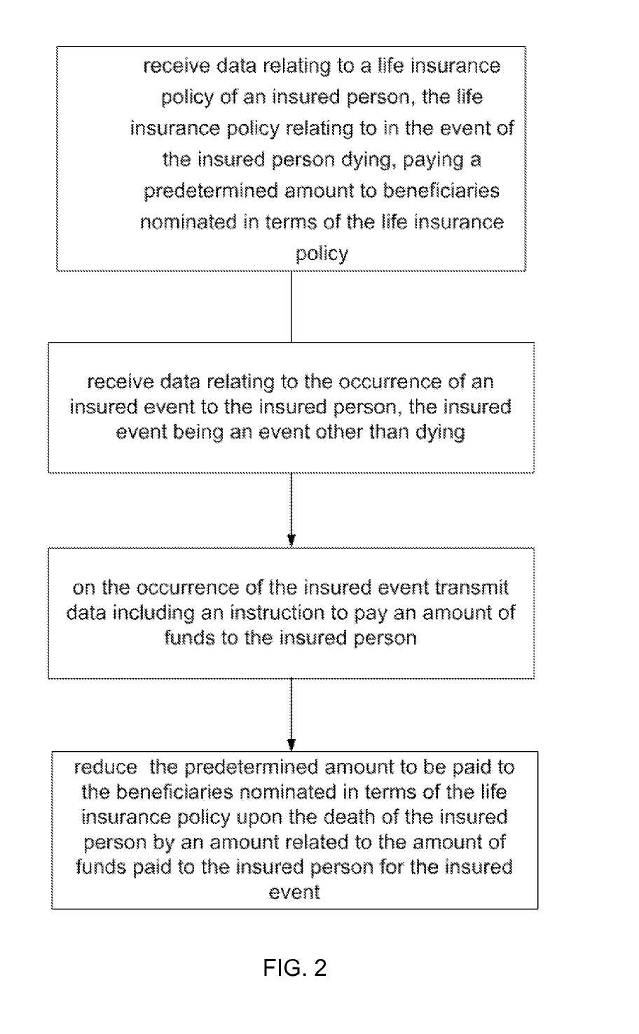

FIG. 3 illustrates a system architecture for a computer system such as a server, work station or other processor on which the disclosure may be implemented.

### DETAILED DESCRIPTION OF THE INVENTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language).

In accordance with the disclosure, a failure to collect adequate insurance proceeds after an insured event may lead to an individual having to sell his personal assets (for example, a car or house), or redeem an investments on unfavourable terms, in order to pay bills resulting from the insured event, or to replace income lost as a result of the insured event. Accordingly, on the occurrence of a life changing adverse event, there is often a need for additional finances to help cope with the effects of the event, addressed by the instant disclosure.

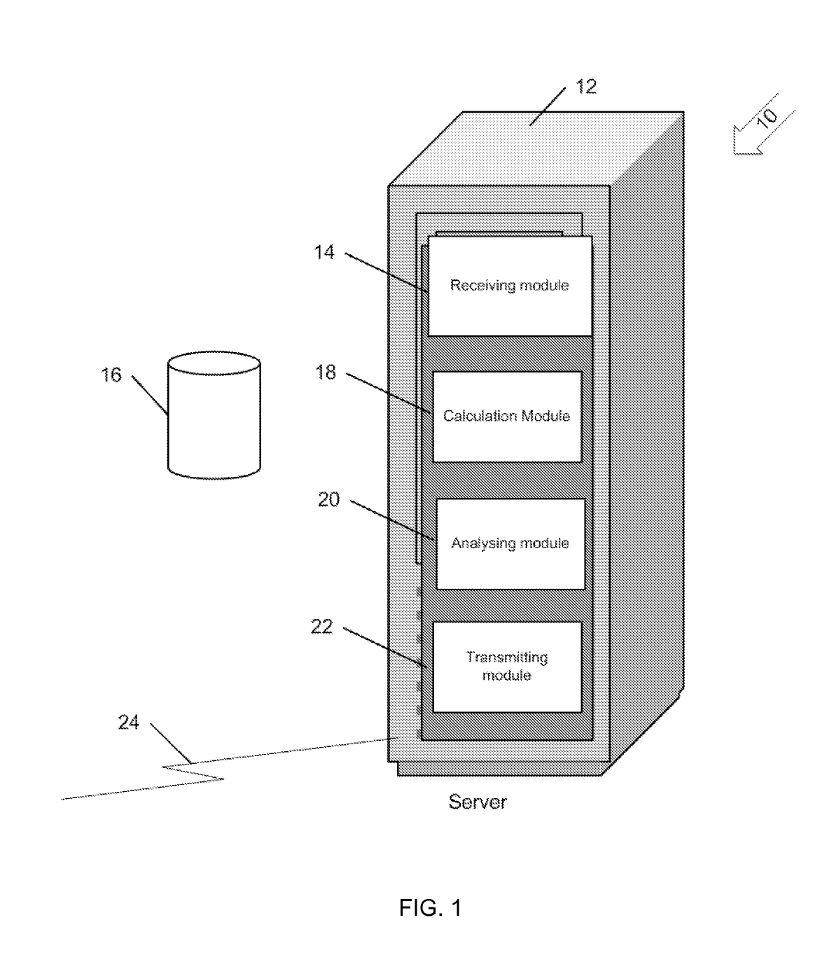

Referring to FIG. 1, an information processing system 10 may include a server 12 that includes a number of modules to implement an example embodiment. In one example embodiment, the modules described below may be implemented by a machine-readable medium embodying instructions which, when executed by a machine, cause the machine to perform any of the methods described above. In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions. It will also be appreciated that in any of these cases the modules form a physical apparatus with physical modules specifically for executing the steps of the method described herein.

In the illustrated example embodiment, the server 12 includes a receiving module 14 to receive data and to write the data to a memory 16. The memory 16 is typically in the form of a database associated with the server 12. The receiving module 14 receives data including data relating to a life insurance policy of an insured person, the life insurance policy relating to in the event of the insured person dying, paying a predetermined amount to beneficiaries nominated in terms of the life insurance policy. The receiving module 14 also receives data relating to the occurrence of an insured event to the insured person, the insured event being an event other than dying.

The life changing adverse event may be one of the group consisting of: severe illness, capital disability, very high health medical expenses, a motor vehicle accident, spouse or child sickness or disability, converting cover into cash to meet the funding needs associated with longevity, death of a person other than the insured life and adverse moments in investment values.

It will be appreciated that on the occurrence of a life changing adverse event, there is often a need for additional finance to help cope with the effects of the event. In the present embodiment, on the occurrence of at least one of a defined set of adverse events, the insured person will be able to effectively access their life cover by converting it at a conversion ratio into cash. For example, the conversion ratio of stage IV cancer is, for example, 2:1. An insured person who gets stage IV cancer will be able access their life cover at a conversion rate of R1 now for every R2 of life cover used. This may be used to pay for new treatments overseas or help cope with the impacts on the family, for example.

Thus, if the insured person has life cover of R500,000 and they feel they require now R100,000 to deal with the present adverse event, they would receive a cash payment of R100,000 and their life cover would be reduced by a ratio of 2:1, being reduced by 8200,000 to a new life cover value of R300,000. Thus, if after the adverse event and the drawdown of R200,000 the insured person dies, their beneficiaries will only be paid out R300,000.

In another example, if the insured person's spouse gets severely ill, his cover can be converted to cash to help with rehabilitation.

In one embodiment, the amount required is selected by the insured person. In an example, the selection is entered by the insured person into a computer and transmitted over a communications network 24 to be received by the receiving module 14. On the occurrence of the insured event, a calculation module 18 calculates the above conversion and reduces the predetermined amount to be paid to the beneficiaries nominated in terms of the life insurance policy upon the death of the insured person by an amount related to the amount of funds paid to the insured person for the insured event, as described above.

A message is then transmitted including an instruction to pay an amount of funds to the insured person. Where the payment is to be effected by the server 12 the message is internally transmitted between modules. However, where the payment is to be made by a third party financial system, the message is transmitted to a server of the third party financial system over the communications network 24 by a transmitting module 22.

The predetermined amount to be paid to the beneficiaries nominated in terms of the life insurance policy upon the death of the insured person is reduced by a predetermined ratio to the amount of funds paid to the insured person for the insured event as has been described above. In one example embodiment the ratio is altered depending on the life changing adverse event according to table 1.

TABLE 1
Ratios for Life Changing Events

| | | | Conversion |
|---|---|---|---|
| | Category | Severity | rate |
| Insured | Severe Illness | A | 2:1 |
| Person | | B | 3:1 |
| | | C | 4:1 |
| | | D | 8:1 |
| | Capital | A | 2:1 |
| | Disability | B | 3:1 |
| | Retirement | Reaching age 80 | 6:1 |
| | | Reaching age 85 | 4:1 |
| | | Reaching age 90 | 3:1 |
| | | Reaching age 95 | 2:1 |
| | | Reaching age 100 | 1.5:1 |
| Spouse | Severe Illness | A | 6:1 |
| | | B | 8:1 |
| | | C | 10:1 |
| | | D | 12:1 |
| | Capital | A | 6:1 |
| | Disability | B | 8:1 |

In the example the severities are used to grade how much of the life cover could be converted into cash with A getting the highest conversion and D getting a lower conversion. Put another way, the more severe the life changing adverse event the smaller the ratio will be. Thus it will be appreciated that in the above example, the amount of the reduction of the predetermined amount is calculated based on the set of conversion factors in the table.

Another example conversion ratio is as shown in Table 2, where the cents (c) indicate how much of R1 life cover will be paid to the insured person in cash.

TABLE 2
Conversion Ratios
Stage 4 cancer

| | |
|---|---|
| Prostate | 70c |
| Malignant melanoma | 75c |
| Ovarian | 85c |
| Pancreas | 85c |
| Stomach | 75c |
| Colorectal | 75c |
| Esophagus | 85c |
| Lung cancer | 85c |
| Soft tissue sarcoma | 70c |
| Bone sarcoma | 35c |
| Brain tumours, WHO grade 3 and 4 | 80c |

Organ transplants

| | |
|---|---|
| Heart | 35c |
| Lung | 45c |
| Heart & lung | 55c |
| Liver | 35c |
| Pancreas | 35c |
| Bone marrow | 35c |

Gastrointestinal tract

| | |
|---|---|
| Liver failure | 65c |
| Portal hypertension | 65c |

Neurological disorders

| | |
|---|---|
| Motor neuron disease, | 35c |
| Multiple sclerosis | 35c |
| Parkinson's | 35c |
| Stroke | 35c |
| Alzheimer disease | 35c |
| Dementia | 35c |
| Dementia due to stroke | 45c |

CVS

| | |
|---|---|
| Permanent ejection fraction of less than 30% | 35c |

Respiratory system

| | |
|---|---|
| Permanent Dco < 40% or FEV1 < 40%, FVC < 40 | 45c |

Renal

| | |
|---|---|
| Stage 4 or 5 renal impairment | 65c |

Connective tissue disorders

| | |
|---|---|
| Scleroderma | 70c |
| PAN | 70c |
| Wegeners | 70c |
| SLE with renal impairment | 70c |
| Rheumatoid Arthritis with renal or cardiac impairment | 70c |

It will be appreciated that the above are examples of how the conversation ratio could be implemented but other conversion ratios could also be applied to different conditions to those listed above.

An example of implementation using the above is as follows. Mr A has R1,000,000 life cover. He is diagnosed with stage 4 stomach cancer. The example above allows him to receive 75c for each rand of life cover he chooses to access and he can therefore access up to R1,000,000 from his life cover for cancer and receive a payment of R750,000. The amount of life cover the client can exercise may depend on different qualifying criteria.

Thus it will be appreciated that the method effectively turns existing life insurance cover into a bank account and allows individuals who have experienced an adverse event to draw cash out of their life cover at a conversion factor to access funding when they need it to meet their obligations. It allows the transferability of life cover which is payable on death to be used while alive to finance the impact of the life changing event.

The disclosure thus enables the transfer of benefits from one unused benefit to another needed one at the time of the event and so applies across benefits, across financial needs (e.g. health, short term, investments) and across lives.

In an alternate embodiment, the insurance policy used to fund the insured event at a predetermined ration is an insurance policy other than a life insurance policy. The working of the reduction and payment are the same as has been described above.

Computer System

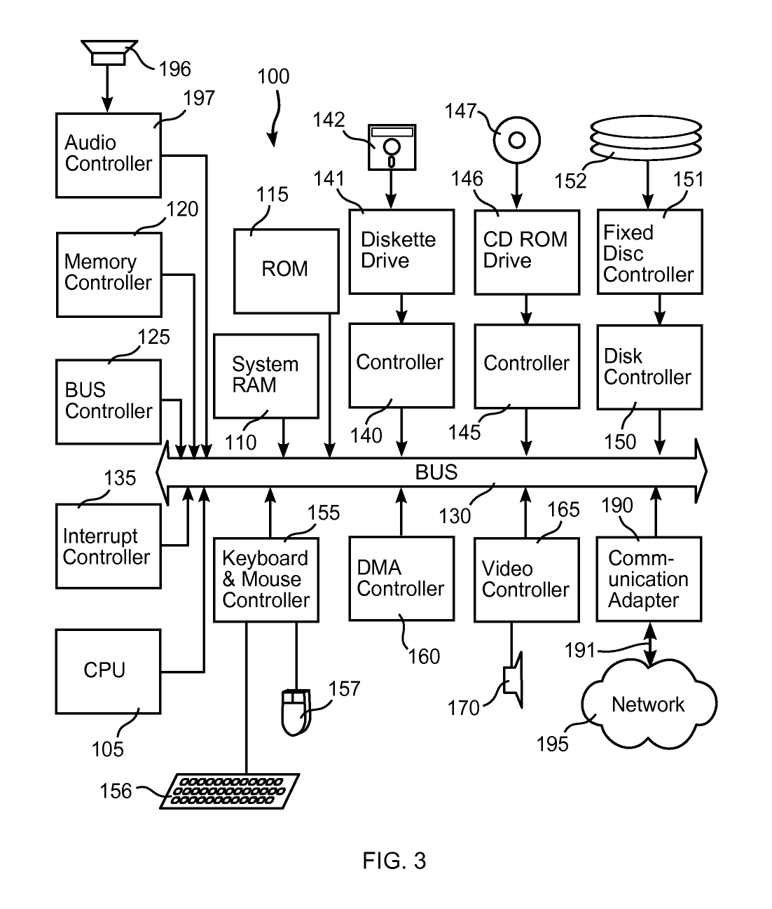

FIG. 3 illustrates the system architecture for a computer system 1000 such as a server, work station or other processor on which the disclosure may be implemented. The exemplary computer system of FIG. 3 is for descriptive purposes only. Although the description may refer to terms commonly used in describing particular computer systems, the description and concepts equally apply to other systems, including systems having architectures dissimilar to FIG. 3.

Computer system 1000 includes at least one central processing unit (CPU) 105, or server, which may be implemented with a conventional microprocessor, a random access memory (RAM) 110 for temporary storage of information, and a read only memory (ROM) 115 for permanent storage of information. A memory controller 120 is provided for controlling RAM 110.

A bus 130 interconnects the components of computer system 1000. A bus controller 125 is provided for controlling bus 130. An interrupt controller 135 is used for receiving and processing various interrupt signals from the system components.

Mass storage may be provided by diskette 142, CD or DVD ROM 147, flash or rotating hard disk drive 152. Data and software, including software 400 of the disclosure, may be exchanged with computer system 1000 via removable media such as diskette 142 and CD ROM 147. Diskette 142 is insertable into diskette drive 141 which is, in turn, connected to bus 30 by a controller 140. Similarly, CD ROM 147 is insertable into CD ROM drive 146 which is, in turn, connected to bus 130 by controller 145. Hard disk 152 is part of a fixed disk drive 151 which is connected to bus 130 by controller 150. It should be understood that other storage, peripheral, and computer processing means may be developed in the future, which may advantageously be used with the disclosure.

User input to computer system 1000 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices, such as a pen and/or tablet, Personal Digital Assistant (PDA), mobile/cellular phone and other devices, may be connected to bus 130 and an appropriate controller and software, as required. DMA controller 160 is provided for performing direct memory access to RAM 110. A visual display is generated by video controller 165 which controls video display 170. Computer system 1000 also includes a communications adapter 190 which allows the system to be interconnected to a local area network (LAN) or a wide area network (WAN), schematically illustrated by bus 191 and network 195.

Operation of computer system 1000 is generally controlled and coordinated by operating system software, such as a Windows system, commercially available from Microsoft Corp., Redmond, Wash. The operating system controls allocation of system resources and performs tasks such as processing scheduling, memory management, networking, and I/O services, among other things. In particular, an operating system resident in system memory and running on CPU 105 coordinates the operation of the other elements of computer system 1000. The present disclosure may be implemented with any number of commercially available operating systems.

One or more applications, such as an HTML page server, or a commercially available communication application, may execute under the control of the operating system, operable to convey information to a user.

All references cited herein are expressly incorporated by reference in their entirety. There are many different features to the present disclosure and it is contemplated that these features may be used together or separately. Unless mention was made above to the contrary, it should be noted that all of the accompanying drawings are not to scale. Thus, the invention should not be limited to any particular combination of features or to a particular application of the disclosure. Further, it should be understood that variations and modifications within the spirit and scope of the invention might occur to those skilled in the art to which the invention pertains. Accordingly, all expedient modifications readily attainable by one versed in the art from the disclosure set forth herein that are within the scope and spirit of the present invention are to be included as further embodiments of the present invention.

1. A method of managing an insurance plan, including:
using one or more computer servers connected to software stored on non-transitory media, the software configure for—
receiving data relating to a life insurance policy of an insured person, the life insurance policy relating to in the event of the insured person dying, paying a predetermined amount to beneficiaries nominated in terms of the life insurance policy;
receiving data relating to the occurrence of an insured event to the insured person, the insured event being an event other than dying;
on the occurrence of the insured event transmitting data including an instruction to pay an amount of funds to the insured person; and
reducing the predetermined amount to be paid to the beneficiaries nominated in terms of the life insurance policy upon the death of the insured person by an amount related to the amount of funds paid to the insured person for the insured event.

2. A method according to claim 1 wherein the amount of the reduction of the predetermined amount is calculated based on a set of conversion factors.

3. A method according to claim 1 wherein the insured event is a life changing adverse event.

4. A method according to claim 3 wherein the life changing adverse event is one of the group consisting of: severe illness, capital disability, very high health medical expenses, a motor vehicle accident, spouse or child sickness or disability, converting cover into cash to meet the funding needs associated with longevity, death of a person other than the insured life and adverse moments in investment values.

5. A method according to claim 1 wherein the predetermined amount to be paid to the beneficiaries nominated in terms of the life insurance policy upon the death of the insured person is reduced by a predetermined ratio to the amount of funds paid to the insured person for the insured event.

6. A method according to claim 5 wherein the reduction is greater than the amount of funds paid to the insured person for the insured event.

7. A method according to claim 5 wherein the ratio is altered depending on the life changing adverse event.

8. A method according to claim 5 wherein the more severe the life changing adverse event the smaller the ratio will be.

9. A system for managing an insurance plan, the system including:
one or more computer servers connected to software stored on non-transitory media, the software configure for—
receiving data relating to a life insurance policy of an insured person, the life insurance policy relating to in the event of the insured person dying, paying a predetermined amount to beneficiaries nominated in terms of the life insurance policy, the receiving module for receiving further data relating to the occurrence of an insured event to the insured person, the insured event being an event other than dying;
calculating a reduction in the predetermined amount to be paid to the beneficiaries nominated in terms of the life insurance policy upon the death of the insured person by an amount related to an amount of funds to be paid to the insured person for the insured event; and
transmitting, on the occurrence of the insured event, data including an instruction to pay an amount of funds to the insured person.

10. A system according to claim 9 wherein calculating includes calculating the amount of the reduction based on a set of conversion factors.

11. A system according to claim 9 wherein the insured event is a life changing adverse event.

12. A system according to claim 11 wherein the life changing adverse event is one of the group consisting of: severe illness, capital disability, very high health medical expenses, a motor vehicle accident, spouse or child sickness or disability, converting cover into cash to meet the funding needs associated with longevity, death of a person other than the insured life and adverse moments in investment values.

13. A system according to claim 9 wherein calculating reduces the predetermined amount to be paid to the beneficiaries nominated in terms of the life insurance policy upon the death of the insured person by a predetermined ratio to the amount of funds paid to the insured person for the insured event.

14. A system according to claim 13 wherein the reduction is greater than the amount of funds paid to the insured person for the insured event.

15. A system according to claim 13 wherein calculating alters the ratio depending on the life changing adverse event.

16. A system according to claim 9 wherein the more severe the life changing adverse event the smaller the ratio will be.
